(19) United States
(12) Patent Application Publication
(10) Pub. No.: US 2006/0238823 A1
(43) Pub. Date: Oct. 26, 2006

(54) Image processing system and apparatus thereof

(75) Inventor: Makoto Harigae, Tokyo (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/115,839

(22) Filed: Apr. 26, 2005

(51) Int. Cl. H04N 1/40

(52) U.S. Cl. 358/448

(57) ABSTRACT

An embodiment according to the present invention is an image data processing system comprising a controller apparatus on a client side and an image forming apparatus of on a server side which are connected through a PCI bus in order to exchange information. When reading or writing file data stored in a storage device of the image forming apparatus, the controller apparatus accesses the file data through a memory space mapped to the PCI bus space on the target apparatus and by the use of the bus master facility, so that the software on the client side and the software on the server side can cooperate by using the file systems implemented in the both sides, and therefore the processing speed is increased.

### BACKGROUND OF THE INVENTION

1. Field of the Invention

The present invention relates generally to an image data processing apparatus and an image data processing method. More specifically, the present invention relates to an image data processing method and an image data processing apparatus which includes, for example, an image forming apparatus such as a printer or an MFP (Multi-Function Peripherals) serving as a multifunctional center apparatus, and a controller apparatus connected to the image forming apparatus such that, for example, one apparatus accesses the other apparatus, reads file data stored in the other apparatus, saves its own storage is device, and processes the file data.

2. Description of the Related Art

In general, an image forming apparatus such as a printer or an MFP serving as a multifunctional center apparatus is connected to a controller apparatus through, for example, a PCI bus and the like, such that the image forming apparatus and the controller apparatus can exchange data through the PCI bus and the like.

This PCI (Peripheral Component Interconnect) bus can provide a 1066 MHz data rate at a maximum on a data bus of 64 bits in accordance with PCI-X revision 1.x, and therefore it is possible to realize the high speed data transmission among apparatuses.

In the case where one apparatus uses a PCI bus as a bus master for the purpose of accessing another apparatus for reading or writing data, this one apparatus issues a bus use request and can start transmitting data after getting bus ownership. When there are a plurality of bus masters which are issuing bus use requests competing with each other on the PCI bus, arbitration algorithm is used to arbitrate the bus use ownership among the bus masters in order that only one of the bus masters can use the bus. This arbitration is performed by a bus arbiter.

Meanwhile, in the case of a prior art technique, one apparatus has to repeat the steps, required for accessing file data stored in the target apparatus, such as the steps of opening, reading or writing, and then closing a file at the opposite apparatus through the PCI bus and the steps of reading or writing the read or write data in the memory space of this one apparatus through the memory space of the target apparatus and through the PCI bus. Furthermore, the control must be performed in compliance with the file system of the opposite apparatus so that a lot of time is needed for data transfer and that the control becomes complicated.

For example, in the case where the controller apparatus connected to the image forming apparatus through the PCI bus reads file data from a storage medium, such as a HDD, provided in the image forming apparatus for processing the file data, the image forming apparatus reads the file data from the storage medium, temporarily stores the file data in an embedded memory and transfers the file data to the controller apparatus through the PCI bus, while the controller apparatus receives the file data through the PCI bus and writes the file data to a storage device provided therein.

In this case, while the data is transferred through the PCI space which is used by the image forming apparatus, since the data transfer and various processes are performed by the use of the same PCI space, a bus request may sometimes be suspended, and the read or write operation may not be performed at a time to take a longer time.

This kind of an image forming apparatus is described, for example, in Japanese Patent Published Application No. Hei 2001-292284. This publication discloses an image input/output apparatus which is provided with a plurality of drums capable of outputting color or monochrome pictures, connected to a drawing apparatus or an image input apparatus through a PCI bus, and serves, if need arises, as a bus master for reading image data to be transferred to the memory of the drawing apparatus or the image input apparatus in an appropriate timing required of the respective drums.

### BRIEF SUMMARY OF THE INVENTION

According to an embodiment of the present invention, it is an object of the present invention to provide an image data processing method and an image data processing apparatus capable of increasing the speed of reading/writing a file between an image forming apparatus and a controller apparatus and the like which are connected through a PCI bus.

The present invention may provide an image data processing system in which a first image data processing apparatus and a second image data processing apparatus are connected through a bus in order to exchange information, wherein

one of said first and second image data processing apparatuses includes a storage device that stores image data, and client software,

wherein the other image data processing apparatus includes a storage device that stores image data, and server software which responds to a read/write request when the request is issued by said first image data processing apparatus, and

wherein when said one image data processing apparatus accesses the storage device of the other image data processing apparatus, the access operation is performed through a memory space, which is mapped to a bus space by the other image data processing apparatus, and by the use of a bus master facility.

The present invention may provide an image forming apparatus connectable to a controller apparatus through a bus,

wherein software for data processing and a storage device for storing image data are implemented in said image data processing apparatus, and a memory space is mapped to said bus, and

wherein, when the controller apparatus connected through said bus performs an access operation to said storage device including a request for read or writing data, said storage device can be accessed through the memory space mapped to said bus and by the use of a bus master facility.

### BRIEF DESCRIPTION OF THE DRAWING

The accompanying drawings, which are incorporated in and constitute a part of the specification, illustrate presently preferred embodiments of the invention.

FIG. 1 is a view showing the overall configuration of the image data processing apparatus according to an embodiment of the present invention.

FIG. 2 is a block diagram showing the configuration of the image data processing apparatus according to the embodiment of the present invention.

FIG. 3 is a view showing the memory space of the PCI bus for use in the image data processing apparatus according to the present invention.

FIG. 4 is a diagram showing data transfer sequence between the image forming apparatus and the controller apparatus according to the present invention.

### DETAILED DESCRIPTION OF THE INVENTION

Hereinafter, embodiments of the present invention will be explained in detail with reference to the attached drawings.

The image data processing apparatus according to an embodiment of the present invention makes it possible to transfer information between a first image data processing apparatus on the client side and a second image data processing apparatus on the server side which are connected to each other through a bus. The above bus is, for example, a PCI bus.

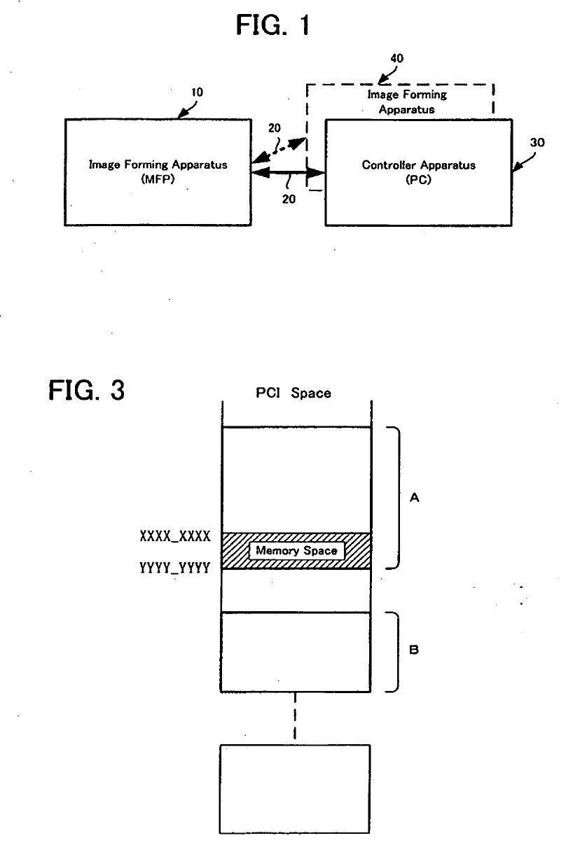

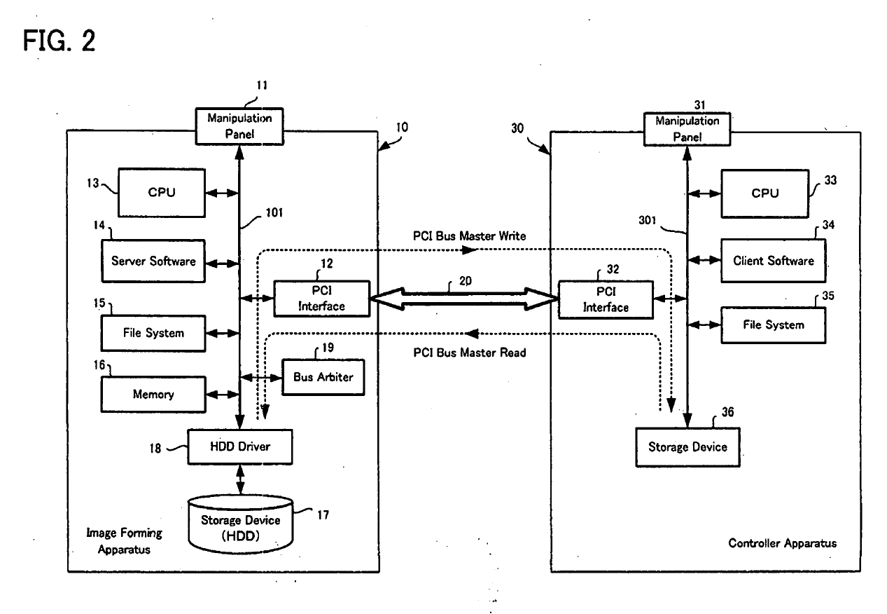

FIG. 1 is a view schematically showing the overall configuration of the image data processing apparatus according to the embodiment of the present invention, and FIG. 2 is a block diagram specifically showing the overall configuration of the image data processing apparatus according to the embodiment of the present invention.

The image data processing apparatus of FIG. 1 comprises an image forming apparatus 10, and a controller apparatus 30 which is connected to this image forming apparatus 10 through a PCI bus 20. The controller apparatus 30 is an apparatus on the client side, and may be a personal computer (PC), an accelerator coprocessor for assisting a drawing apparatus, or the like. On the other hand, the image forming apparatus 10 is an apparatus on the server side, and may be an MFP, a printer or the like.

Alternatively, the present invention can be applied to an embodiment as illustrated in FIG. 1 with a broken line indicative of an image forming apparatus 40 which is provided as an apparatus on the client side.

Meanwhile, in the following explanation, it is assumed that an MFP (Multi-Function Peripherals) is an example of the image forming apparatus 10 and that a personal computer (PC) is an example of the controller apparatus 30.

As illustrated in FIG. 2, the image forming apparatus 10 has a manipulation panel section 11 and an PCI interface 12, the controller apparatus 30 has a manipulation panel section 31 and a PCI interface 32, and the image forming apparatus 10 and the controller apparatus 30 are connected to each other through a PCI bus 20 by the use of the PCI interfaces 12 and 32.

The image forming apparatus 10 includes a bus 101 is connected to the PCI interface 12, a CPU 13 connected to this bus 101, server software 14, a file system 15, and a memory 16 for storing data, and provided with a storage device 17 such as a HDD, a HDD driver 18, and a bus arbiter 19. The image forming apparatus 10 is further provided with a print engine and so forth which are omitted from the illustration.

The manipulation panel section 1 includes a display and operation keys for receiving input from a user, while the CPU 13 takes control of the overall operation of the image forming apparatus 10 in accordance with a control program. The server software 14 is software which executes a particular process in response to a request from the client side (the controller apparatus 20). In addition, the file system 15 serves to manage electronic files and search for a file which an user wants to print, while the memory 16 for storing data is used to temporarily save data when file data stored in the storage device 17 is read for printing process.

Also, the bus arbiter 19 is provided, as the need arises, and serves to grant bus ownership to an apparatus as a bus master by arbitrating the bus use requests issued from a plurality of bus masters on the PCI bus and give bus use permission to one of the plurality of bus masters.

On the other hand, the controller apparatus 30 has a bus 301 connected to the PCI interface 32, a CPU 33 connected to this bus 301, client software 34, a file system 35, and a storage device 36 for storing data.

The manipulation panel section 31 includes a display and manipulation keys for receiving input from a user, the CPU 33 takes control of the overall operation of the controller apparatus 30 in accordance with a control program, and the client software 34 is software for issuing a processing request to the image forming apparatus 10 and receiving a processing result. In addition, the file system 35 serves to manage electronic files, and the data storage device 36 is capable of saving the file data as read from the storage device 17 of the image forming apparatus 10.

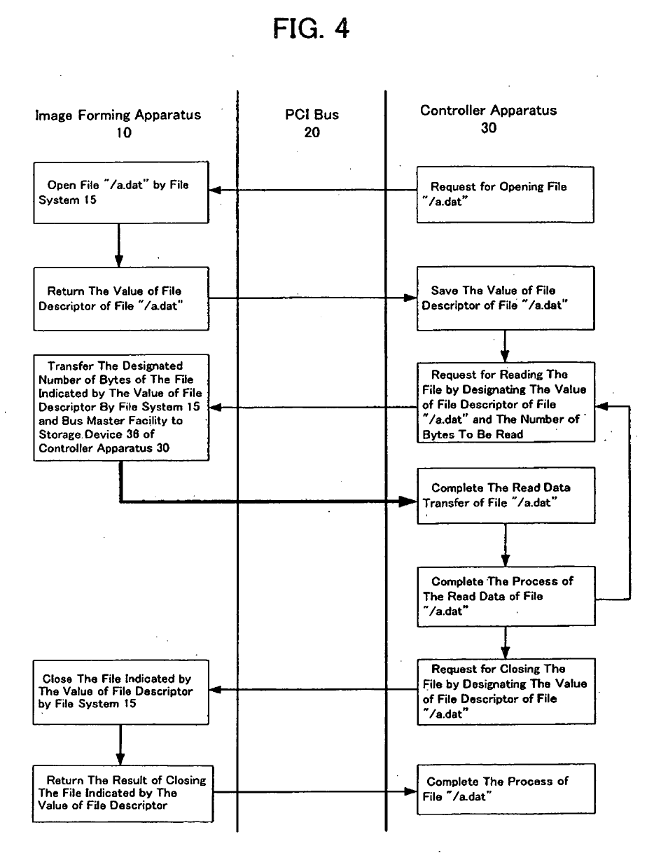

Next, the operation of the image data processing apparatus according to the embodiment of the present invention will be explained with reference to FIG. 3 and FIG. 4. FIG. 3 is a schematic view showing the memory space of the PCI bus 20, and FIG. 4 is a flow diagram showing data transfer sequence between the image forming apparatus 10 and the controller apparatus 30.

Namely, in accordance with the present invention, it is possible to directly read or write a file through a memory space of the opposite apparatus, which is mapped to the PCI space, by the use of the PCI bus 20 for connecting the image forming apparatus 10 and by the use of a bus master facility.

The server software 14 is installed in the image forming apparatus 10 in order to respond to requests from the controller apparatus 30, and the client software 34 is installed in the controller apparatus 30 in order to issue requests for opening, reading or writing, and then closing a file stored in the storage device (HDD) 17 of the image forming apparatus 10. Also, the specifications (to be described below) of the respective functions for opening, reading or writing, and then closing a file are designed in compliance with the file system of the opposite apparatus, and the storage device 36 of the controller apparatus 30 is mapped to the PCI space XXXX_XXXX˜YYYY_YYYY of the PCI interface 20 as illustrated in FIG. 3. Namely, at the controller apparatus 30, the space of the storage device 36 (referred to herein as the memory space) is mapped to the PCI space.

In addition, while the bus master facility is used to speed up the process, the server software 14 and the client software 34 are used to make it possible for the client side to read and write a file of the opposite apparatus (the server side) as if the client were accessing its own file

For example, when there is a request from the controller apparatus 30 for reading or writing, the reading or writing request is transferred to the server software 14 by the client software 34, and the server software 14 makes use of the file system 15 of the image forming apparatus 10 in order to read or write file data through the HDD driver 18. The data as read or written is transferred to the storage device 36, without the use of the memory 16, through the PCI interface 12, the PCI bus 20 and the PCI interface 32, so that the file data of the storage device (HDD) 17 can be transferred directly to the storage device 36 through the PCI interfaces 12 and 32.

This is realized by the use of the memory space XXXX_XXXX˜YYYY_YYYY which is mapped to the PCI space so that the image forming apparatus 10 can directly access the storage device 36 of the controller apparatus 30.

FIG. 3 is a schematic diagram showing an example of the PCI space in which the PCI space A of the image forming apparatus 10 and the PCI space B of the controller apparatus 30 are mapped and the memory space XXXX_XXXX˜YYYY_YYYY of the storage device 36 is mapped to the PCI space A of the image forming apparatus 10. Accordingly, in the case where the controller apparatus 30 accesses the storage device (HDD) 17 of the image forming apparatus 10 to read or write data stored in the HDD 17 from or to the storage device 36 of the controller apparatus 30, the transmission of data is performed through this memory space XXXX_XXXX˜YYYY_YYYY. In addition to this, since the bus master facility is used for data transfer, it is possible to improve the transfer speed.

Incidentally, in FIG. 2, when the controller apparatus 30 reads the data of the HDD 17, the image forming apparatus 10 serves as a bus master while this operation is referred to as “PCI bus master write”. Also, in the case where data stored in the storage device 36 of the controller apparatus 30 is written to the HDD 17 of the image forming apparatus 10, the image forming apparatus 10 serves as a bus master while this operation is referred to as “PCI bus master read”.

FIG. 4 shows an exemplary sequence of data transfer between the image forming apparatus 10 and the controller apparatus 30. This is a schematic diagram showing data transaction between the server software 14 installed in the image forming apparatus 10 and the client software 34 installed in the controller apparatus 30.

Namely, the software control of the image forming apparatus 10 is described in the left hand side of FIG. 4, and the software control of the controller apparatus 30 is described in the right hand side of the figure. At first, it is assumed that the controller apparatus 30 issues a request for opening a file to the image forming apparatus 10. In this case, it is assumed that a file (provisionally given “/a.dat” as its file name) at the top level is requested.

In response to this, the image forming apparatus 10 opens the file “/a.dat” stored in the storage device 17 by making use of the file system 15 thereof, and returns to the controller apparatus 30 the value of the file descriptor of the file “/a.dat” indicative of the name of the file, the type of the file and the size of the file).

The controller apparatus 30 saves the value of the file descriptor of the file “/a.dat”, and then issues a read request by designating the value of the file descriptor and the number of bytes to be read.

In response to this, the image forming apparatus 10 transfers the designated number of bytes of the file indicated by the value of the file descriptor to the storage device 36 of the controller apparatus 30 by making use of the file system 15 and the bus master facility.

After the data transfer of the file “/a.dat” to the storage device 36 of the controller apparatus 30 is completed, the controller apparatus 30 processes the data of the file “/a.dat” as read and issues a read request again to the image forming apparatus 10 if the read operation is to continue.

Then, when the controller apparatus 30 finishes processing the data of the file “/a.dat” as read, the controller apparatus 30 issues a request for closing the file “/a.dat” by designating the value of the file descriptor to the image forming apparatus 10. In response to this, the image forming apparatus 10 closes the file indicated by the file descriptor by the use of the file system 15. Then, the image forming apparatus 10 returns the result of closing the file indicated by the file descriptor.

In this way, the controller apparatus 30 can complete the process of the file “/a.dat” as requested.

Incidentally, the respective functions of opening, reading, writing and closing a file are provided in compliance with the file system of the opposite apparatus (the server side). More specifically speaking, a file is managed in the file system by dividing it in units of clusters, providing an FAT (File Allocation Table) which contains the locations and the like of the respective clusters such that the file can be read or written by sequentially tracing data locations with reference to this FAT information.

For example, in the case of Windows, as it is known, file systems such as FAT32, NTFS are used while the specifications of the functions given names including “open”, “read”, “write” and “close” are defined for accessing files of these file systems, so that the server system is designed to provide stub functions (for example, functions named “sfopen”, “sfread”, “sfwrite” and “sfclose”) for performing the operations of opening, reading, writing and closing a file in compliance with these specifications in response to the request of accessing a file issued from the opposite apparatus (the client system).

As has been discussed above, in accordance with the present invention, the controller apparatus 30 can directly read and write a file stored in the storage device (HDD) 17 of the image forming apparatus 10 by accessing the memory space that is mapped to the PCI space of the image forming apparatus 10, while the operations of opening, reading, writing and closing a file of the image forming apparatus 10 can be performed by both the client software 34 and the server software 14 so that the controller apparatus 30 can handle a file of the opposite apparatus as if it were accessing its own file system. Because of this, the processing speed is increased.

Incidentally, while the embodiment as described above is explained relating to the connection between the image forming apparatus 10 and the controller apparatus 30, the present invention is not limited to this example but can be applied, for example, to the case where two image forming apparatuses (such as MFPs) are connected together through a PCI bus. Like the previous embodiment, also in this case where two image forming apparatuses are connected together, one apparatus accesses the target apparatus by accessing the memory space that is mapped to the PCI space by the opposite apparatus by the use of the PCI bus master facility in order that the software for accessing files of own apparatus and the target apparatus can make use of the file systems of the both apparatuses, and therefore the processing speed is increased.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the present invention.

What is claimed is:

1. An image data processing system in which a first image data processing apparatus and a second image data processing apparatus are connected through a bus in order to exchange information, wherein
one of said first and second image data processing apparatuses includes a storage device that stores image data, and client software,
wherein the other image data processing apparatus includes a storage device that stores image data, and server software which responds to a read/write request when the request is issued by said first image data processing apparatus, and
wherein, when said one image data processing apparatus accesses the storage device of the other image data processing apparatus, the access operation is performed through a memory space, which is mapped to a bus space by the other image data processing apparatus, and by the use of a bus master facility.

2. A system as set forth in claim 1, wherein said bus is a PCI bus (Peripheral component interconnect bus).

3. A system as set forth in claim 1, wherein said one image data processing apparatus and the other image data processing apparatus are image forming apparatuses respectively.

4. A system as set forth in claim 3, wherein said image forming apparatus is an MFP (Multi-Function Peripheral).

5. A system as set forth in claim 1, wherein the other image data processing apparatus is an MFP having a HDD, and said one image data processing apparatus is a controller apparatus serving to control said printer.

6. A system as set forth in claim 5, wherein said controller apparatus accesses the other image data processing apparatus with a read or write request by said client software, wherein
the other image data processing apparatus transfers the image data stored in said HDD as a file by said server software in response to the read or write request from said controller apparatus.

7. An image forming apparatus connectable to a controller apparatus through a bus,
wherein software for data processing and a storage device for storing image data are implemented in said image data processing apparatus, and a memory space is mapped to said bus, and
wherein, when the controller apparatus connected through said bus performs an access operation to said storage device including a request for read or writing data, said storage device can be accessed through the memory space mapped to said bus and by the use of a bus master facility.

8. An image forming apparatus as set forth in claim 7, wherein said bus is a PCI bus (Peripheral component interconnect bus).

9. An image forming apparatus as set forth in claim 7, wherein said image forming apparatus is an MFP (Multi-Function Peripheral).

10. An image forming apparatus as set forth in claim 7, wherein said storage device comprises a HDD.
